(19) United States
(12) Patent Application Publication
(10) Pub. No.: US 2007/0061405 A1
(43) Pub. Date: Mar. 15, 2007

(54) Automatically setting an avoidance threshold and adjusting a chat presence based on user avoidance of chat sessions

(76) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny M. Shieh, Austin, TX (US)

Correspondence Address: IBM CORP (AP);C/O AMY PATTILLO, P. O. BOX 161327, AUSTIN, TX, 78716, US

(21) Appl. No.: 11/226,958

(22) Filed: Sep. 15, 2005

(51) Int. Cl. G06F 15/16

(52) U.S. Cl. 709/207

(57) ABSTRACT

A chat presence state adjustment indicating an availability of a particular user to participate in new chat sessions is automatically performed in a computer system. The computer system, which is in communication with a network, includes at least one of a chat server that facilitates chat communications between multiple client systems logged onto by multiple users and a particular client system logged onto by a particular user from among the multiple user. The computer system includes an avoidance controller that first detects a selection of chat sessions avoided by the particular user over a period of time from among the total chat session directed to the particular user over the period of time. In particular, the avoidance controller detects that the user avoids each of the selection of chat sessions through at least one separate type of avoidance activity. Next, the avoidance controller automatically sets at least one avoidance threshold based on at least one threshold characteristic of the selection of chat sessions avoided by the particular user. The avoidance threshold is set so that when future avoidance activity by the particular user exceeds the avoidance threshold, avoidance controller will automatically adjust the chat presence state of the particular user to indicate lack of availability of the particular user to participate in a new chat session.

### BACKGROUND OF THE INVENTION

1. Technical Field:

The present invention relates in general to improved chat service and in particular to automatically adjusting a user's chat presence. Still more particularly, the present invention relates to automatically setting an avoidance threshold based on detected patterns of user avoidance of chat sessions and changing a chat presence based on current user avoidance of new chat requests that exceed the avoidance threshold.

2. Description of the Related Art:

Electronic communications continue to overtake traditional telephone communications. In particular, chat communications provide the capability for several computer system users to “chat” or exchange messages in what appears to be real time. It is typical in chat communications that one user enters and sends a message at one computer system and another user sees that message soon thereafter at another computer system. Further, it is typical in chat communications that users exchange messages within a chat session, where the messages are displayed in order of exchange in a chat session window within each user's computer system display.

Currently, chat communications are implemented in multiple formats including, but not limited to, chat rooms, instant messaging, and Internet Relay Chat (IRC). Typically, chat communication users subscribe to or access a chat service, through the user's computer system, where the chat service facilitates chat communication through one or more of the chat formats. In one example, chat communication users subscribe with chat service providers who may support multiple formats of chat communications. In addition, chat communication users may access a private or local network that includes chat applications for supporting one or more formats of chat communications among network users.

One feature of many chat services is that one user, such as “user A”, may concurrently chat in the different chat formats in multiple independent chat sessions. For example, “user A” may participate in a chat session of a chat room format with “user B” and “user C” and also participate in a chat session of an instant messaging format with “user D”. A separate graphical window may distinguish each chat session.

An important supporting function of chat communications, when a user is logged on to a chat service, is the detection of the “presence” of users to receive and participate in chat sessions. The presence state of a user typically indicates the availability of a user to participate in chat sessions. Some chat services allow a user to select a presence state from a list of availability indicators. For example, the user may select from a range of indicators such as “available”, “busy”, “away from my desk”, and “at a meeting.” When a user does not want to participate in or be disturbed by chat communications, but does not want to or cannot log off from the chat service, some chat services allow the user to select an indicator such as “do not disturb” that indicates to the chat service to block all chat communications to the user.

By monitoring the presence of each user, chat services may provide this indication of whether a user is available or not to other users. Thus, changes to a user's presence state may then become visible to other users of the chat service. Further, some chat services allow each user to select a “buddy list” of other user identifiers, where the chat service will then automatically update each user as to the presence state of those users listed in the buddy list.

In addition to offering a list of availability indicators for setting a presence state, some chat services will also automatically set a user's presence state to “idle” or “away” if a user's computer system sits idle for a particular period of time, such as 15 minutes. When user activity is next detected, the chat service may then automatically return the user's presence state to an active indicator, such as “available”.

Other than detecting idleness versus activity at a computer system, when a user is working on the computer system, however, as the user's workload and availability to respond in chat sessions varies, the chat service does not respond to the variations and the user may not have time to constantly change a presence state. Further, depending on a user's workload on the computer system, a user may begin to avoid some new chat requests or ongoing chat sessions, but not have the time to change a presence state or not want to change to a new presence state that would block all chat communications. In particular, most chat services place each chat request in a prompt window in the foreground of the display. Thus, to avoid a new chat request by continue working in an unobscured display area, the user often has to perform some action, such as closing the window, minimizing the window into an icon, sending the window to the background, or selecting a button in the window to reject the request.

In view of the foregoing, it would be advantageous to provide a method, system, and program for automatically detecting activity over time that is indicative of a user avoiding chat communications and estimating avoidance activity thresholds from previous avoidance activity, such that if a user's current avoidance activity exceeds the avoidance activity thresholds then the user's presence state is automatically adjusted to reflect a current availability.

### SUMMARY OF THE INVENTION

Therefore, the present invention provides improved automated presence state adjustment, such that when a user begins to avoid chat sessions, the user's presence state is adjusted to indicate lack of availability to participate in new chat sessions.

A chat presence state adjustment indicating an availability of a particular user to participate in new chat sessions is automatically performed in a computer system. The computer system, which is in communication with a network, includes at least one of a chat server that facilitates chat communications between multiple client systems logged onto by multiple users and a particular client system logged onto by a particular user.

The computer system includes an avoidance controller that first detects a selection of chat sessions avoided by the particular user over a particular period of time from among the total chat session directed to the particular user over the particular period of time. In particular, the avoidance controller detects that the user avoids each of the selection of chat sessions through at least one separate type of avoidance activity. The avoidance controller may prompt the particular user to verify that each of the separate types of avoidance activity are representative of actual actions taken by the particular user to avoid chat sessions.

Next, the avoidance controller automatically sets at least one avoidance threshold based on at least one threshold characteristic of the selection of chat sessions avoided by the particular user. The avoidance threshold is set so that when future avoidance activity by the particular user exceeds the avoidance threshold, avoidance controller will automatically adjust the chat presence state of the particular user to indicate lack of availability of the particular user to participate in a new chat session.

In particular, for a second selection of chat sessions avoided by the particular user through at least one of the separate types of avoidance activity, over a different period of time, the avoidance controller compares the second selection of chat sessions avoided by the particular user with the avoidance threshold set for the user and automatically adjusts the chat presence state for the particular user to indicate lack of availability to participate in a new chat session if the second selection of chat avoidance exceeds the avoidance threshold.

In addition, as the avoidance controller continues to monitor avoidance activity by the particular user, the avoidance controller continues to detect threshold characteristics of the monitored avoidance activity and adjust the avoidance threshold to reflect the additional threshold characteristics.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting one embodiment of a network environment for supporting chat communications;

FIG. 2 is a block diagram illustrating examples of functional components within a chat server that enables chat service for facilitating chat communications;

FIG. 3 is a block diagram depicting examples of functional components of a chat agent for supporting participation in chat communications;

FIG. 4 is a block diagram illustrating one embodiment of a computing system through which the chat server or chat client system and present method and program product may be implemented;

FIG. 5 is a block diagram depicting avoidance threshold settings for a particular user;

FIG. 6 is an illustrative diagram illustrating one example of an avoidance-based presence state update;

FIG. 7 is a high level logic flowchart depicting a process and program for specifying avoidance based presence states for chat users; and

FIG. 8 is a high level logic flowchart illustrating a process and program for monitoring avoidance activity for a particular user and setting avoidance thresholds based on the monitored avoidance activity.

### DETAILED DESCRIPTION OF THE PREFERRED EMBODIMENT

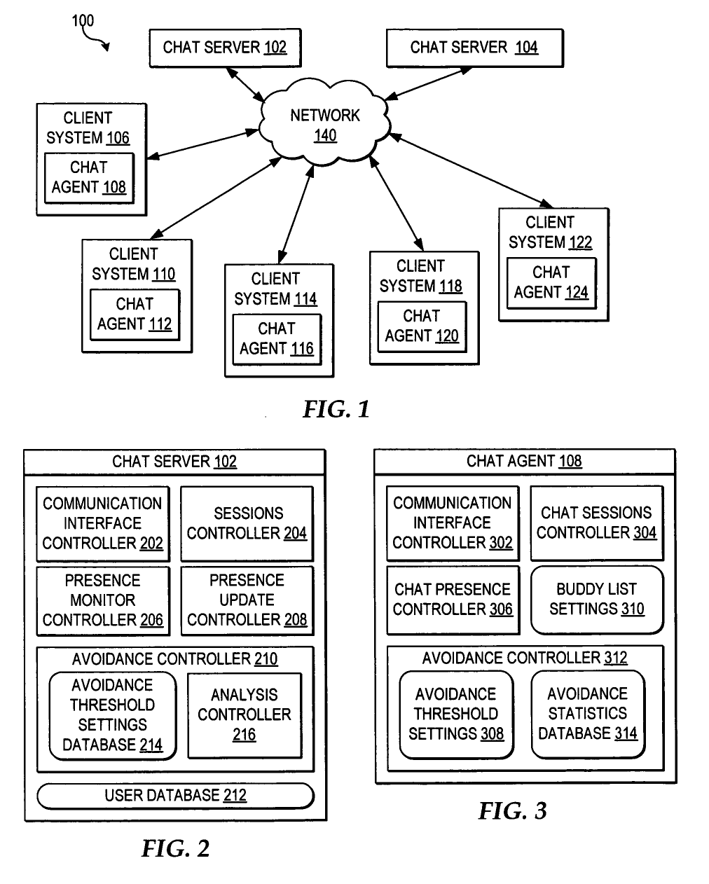

With reference now to FIG. 1, a block diagram depicts a network environment for supporting chat communications in accordance with the method, system, and program of the present invention. As illustrated, a distributed network 100 may include at least one server, such as chat server 102 or chat server 104, communicatively connected to network 140, for facilitating chat communications In addition, distributed network 100 may include multiple client systems communicatively connected to network 140, such as client systems 106, 110, 114, 118, and 122, for participating in chat communications. It will be understood that additional computing server and client systems may communicatively connect to network 140 within distributed network 100 for controlling chat communications. Network 140 may include permanent connections such as wire or fiber optics cables and temporary connections made through telephone connections and wireless transmission connections, for example, through which data and control information may pass.

Chat servers 102 and 104 and client systems 106, 110, 114, 118, and 122 maybe connected within distributed network 100 in conformance with different network architectures. In one example, within a client-server architecture, distributed network 100 is the Internet and network 140 represents a worldwide collection of networks and gateways that the use the transmission control protocol/internet protocol (TCP/IP) suite of protocols to communicate with each other; in another example, distributed network is an intranet and network 140 facilitates a local area network (LAN) or wide area network (WAN). Additionally, within a peer-to-peer architecture, client systems 106, 110, 114, 118, and 122 may directly communicate with each other, in chat communications, via network 140, without a chat server acting as an intermediary. Further, software function calls as may be defined in an application programming interface (API) executing on each of the systems (chat server 102 and 104 and client systems 106, 110, 114, 118, and 122) may be used to implement communication between the systems or systems may communication by passing messages, for example directly through a commonly-defined message passing port interface or indirectly through reading and writing shared memory.

Under the client-server architecture, when two systems communicatively connected to network 140 communicate, the client-server architecture defines the roles that each device plays. In particular, a device communicatively connected to network 140 is considered a client if the device uses chat services and is considered a server if the device provides chat services. While chat server 102 and chat server 104 are specifically described as providing chat services, either of chat server 102 and chat server 104 may also receive chat services in a client role. In addition, while client systems 106, 110, 114, 118, and 122 are specifically described as receiving services, any of client systems 106, 110, 114, 118, and 122 may also provide services in a server role.

Chat servers 102 and 104 may each represent a different chat service provider or the same chat service provider. Additionally, chat servers 102 and 104 may each represent a public chat service provider or a private or enterprise based chat service provider.

Each of client systems 106, 110, 114, 118, and 122 may include a chat agent, such as chat agents 108, 112, 116, 120, and 124, respectively. A chat agent communicates between the client system and the chat server to facilitate chat communications and presence state updates. While chat agents 108, 112, 116, 120, and 124, are depicted as each associated with a particular client system, chat agents may be distributed across multiple systems in a distributed network and multiple client systems and server systems may share a single or multiple chat agents. Additionally, each of client systems 106, 110, 114, 118, and 122 may include multiple chat agents, where each chat agents supports chat communications via a different chat service provider. Further, a chat agent may be a stand-alone application or may be integrated into an operating system of a client system or into another application executing on the client system, such as a web browser.

In facilitating chat communications between client systems, chat servers 102 and 104 may support chat communications in multiple formats including, but not limited to, chat rooms, instant messaging, IRC, and text messaging via multiple types of media including, but not limited to, text, voice, graphics, video, and file transfer.

In addition, in facilitating chat communications between client systems, chat servers 102 and 104 may support monitoring the presence state of each user currently logged in through a chat agent and distributing the presence state of each user to other users logged in through other chat agents. For example, the presence of the user logged in at client system 106 may be broadcast via one of chat servers 102 and 104 to client systems 110, 114, and 118 because the users logged in at these client systems have requested to monitor the presence of the user logged in at client system 106; the user logged in at client system 122 has not requested to monitor the user's presence so the presence state would not be broadcast to client system 122. In another example, the user logged in at client system 106 may request to monitor the presence state of the users logged in at client systems 110 and 114, but not client systems 118 and 122. The users logged in at client systems 118 and 122 would be considered “foreign chat users” to the user logged on at client system 106 if one of these users initiated a chat session with the user logged in at client system 106. Further, according to an advantage, in facilitating chat communications between client systems, chat server 102 and 104 may support distributing multiple different presence states for a particular user based on whether the other users monitoring the presence of the particular user are currently participating in a chat session with the particular user.

Additionally, a chat server or a chat agent may include an avoidance controller, as will be further described. The avoidance controller monitors the interaction of a user with the particular client system and detects activity indicative of the user avoiding chat sessions. For example, activity indicative of a user avoiding chat sessions, also termed “avoidance activity” may include, for example, a user closing a chat request window, a user minimizing a chat request window to an icon, a user sending a chat request window that is currently in the foreground to the background, a user selecting a dismiss option within the chat request window, and a user closing a chat session window after only a single or minimal message response. As will be further described, avoidance activity for a particular may be specified to particular types of activity.

Based on avoidance activity monitored over time, the avoidance controller at the chat server or chat agent selects avoidance thresholds, above which the user's presence state is automatically adjusted to indicate some level of lack of availability. In particular, the presence state adjustment may specify updating some users to the adjustment but not all users. For example, the presence state adjustment may specify not updating the presence state for those users with whom a chat session is in progress or for those users included in preferences to not receive an avoidance-based presence state. In one example, if the avoidance controller at client system 106 sets an avoidance-based presence state and client systems 110, 114, and 118 are monitoring the presence of the user at client system 106, the avoidance controller may specify that only the user at client system 114 should be updated with the avoidance-based presence state.

Once avoidance thresholds are set, the avoidance controller at the chat server or chat agent then monitors current user interaction with a client system, marks actions indicative of avoidance activity, and then determines whether the avoidance activity over time exceeds the avoidance thresholds. When a particular avoidance threshold is exceeded, the avoidance controller automatically adjusts the presence state as specified by the particular avoidance threshold. The chat server will detect the avoidance-based presence state adjustment and control broadcast of the presence state to update other users as specified.

It will be understood that for chat communications, a user may be identified by a user identifier in multiple forms including, but not limited to, an e-mail address, an instant messaging identifier, a chat name, a telephone number, or other electronic identifier.

With reference now to FIG. 2, a block diagram depicts examples of functional components within a chat server that enables chat service for facilitating chat communications in accordance with the method, system, and program of the present invention. In particular, examples of functional components of chat server 102 are depicted. The functional components of chat server 102 for providing chat services may be implemented within multiple network architectural layers, depending on the server system, including, but not limited to, the network layer, the operating system layer, and the application layer. It will be understood, that additional functional components for facilitating chat services may be included in chat server 102 and that the functional components depicted may be performed by multiple disparate server systems or client systems and the functional components depicted may be distributed across multiple server systems and client systems. Additionally, it will be understood that while multiple controllers are depicted within chat server 102 as separate functional components, all or selections of the controllers may be integrated into a single functional component.

As illustrated, chat server 102 includes a communication interface controller 202. Communication interface controller 202 manages the communication between the chat functional components through multiple open server sockets with multiple chat agents. It will be understood that the hardware interfaces of the server system or systems represented as chat server 102 may effect the settings of how communication interface controller 202 supports chat services to chat agents via network 140. In addition, it will be understood that communication interface controller 202 may support communications in different protocols including a single proprietary protocol and multiple disparate protocols.

As depicted, chat server 102 includes a user database 212. User database 212 includes the identifiers of users that subscribe to the chat service offered through chat server 102. A single user may register under one or more identifiers. In addition, a user may specify chat session format preferences, output preferences, and other preferences offered by the chat service, which are stored in user database 212.

In addition, chat server 102 includes a sessions controller 204. Chat sessions controller 204 facilitates the actual chat communication between chat agents through chat sessions in multiple chat formats. For example, sessions controller 204 may support chat room based chat sessions and instant messaging based chat sessions. Sessions controller 204 may restrict and format chat sessions for a particular user based on the chat session preferences associated with the user in user database 212.

In one example, when one user wants to initiate a chat session with another user, the user initiates a chat request at a first chat agent, the first chat agent communicates the chat request to sessions controller 204 and sessions controller 204, upon detection that the requested user is available to receive a chat request, initiates a channel between the two users and sends a chat request prompt to the second user at the second agent logged onto by the second user. A chat request prompt may include options for the second user to accept or dismiss the chat request. Additionally, a chat request prompt may include options for closing the chat request without responding.

Chat server 102 also includes a presence monitor controller 206 and a presence update controller 208. Presence monitor controller 206 determines the presence state of each registered user in user database 212 and in particular monitors the specific presence state of each user currently logged on to chat server 102 through a chat agent. In one embodiment, a user may select a presence state from a list of available presence states. In another embodiment, a controller, such as avoidance controller 310, may automatically select a presence state for a user.

Presence update controller 208 distributes the presence state for a user among other users registered in user database 212. As previously described, presence update controller 208 may update a presence state for a particular user to some other users, but not all other users. Thus, a single user may have multiple simultaneous presence states that vary based on the identity of the other user receiving the presence state.

As previously described, a chat server, such as chat server 102, may include an avoidance controller, such as avoidance controller 210. In one embodiment, avoidance controller 210 monitors the user response to chat requests and in chat sessions, by monitoring sessions controller 204, to detect activity indicative of the user avoiding chat sessions. For example, avoidance controller 210 monitors the number of chat requests initiated by sessions controller 204 and rejected by the user through dismissing the chat request, closing the chat request window, or not responding to the chat request after a particular period of time in which the user is actively participating in other chat sessions. Additionally, avoidance controller 210 may monitor patterns of activity in chat sessions that are indicative of avoidance and prompt the user to indicate whether the user is avoiding the chat session. Further, avoidance controller 210 may receive activity indicators from a chat agent that enable avoidance controller 210 to detect activity indicative of avoidance of chat sessions.

Based on user avoidance activity monitored by avoidance controller 210 over time, avoidance controller 210 may estimate, calculate, and detect patterns for avoidance thresholds, above which the user's presence state should automatically change. Next, avoidance controller 210 continues to monitor user activity, mark avoidance activity, and once avoidance controller 210 detects current avoidance activity exceeding one of the avoidance thresholds, avoidance controller 210 automatically adjusts the user's presence state monitored by presence monitor controller 206. Presence update controller 208 then updates other users with the avoidance-based presence state based on user preferences in user database 212.

In one embodiment, at chat server 102, avoidance controller 210 maintains an avoidance threshold database 214 that includes the monitored avoidance activity for each user and the avoidance thresholds selected for each user. In addition, avoidance controller 210 may include an analysis controller 216 for analyzing avoidance activity and selecting thresholds. In particular, analysis controller 216 may constantly monitor the avoidance activity patterns of different users to learn additional types of user activity that may be indicative of avoidance and to select thresholds based on typical user thresholds for certain types of avoidance activity.

In another embodiment, presence monitor controller 206 determines the presence state of a user by receiving a presence state adjustment from the chat agent through which the user is logged on. As will be further described, a chat agent may automatically set an avoidance based presence state or a user may select a new presence state. If the presence state adjustment indicates the presence state is an avoidance-based presence state, then the adjustment may also indicate selections of users to which the updated presence state should be distributed.

Referring now to FIG. 3, a block diagram depicts examples of functional components of a chat agent for supporting participation in chat communications in accordance with the method, system, and program of the present invention. In particular, examples of functional components of chat agent 108 are depicted. The functional components of chat agent 108 may be implemented within multiple network architectural layers, depending on the client system, including, but not limited to, the network layer, the operating system layer, and the application layer. In addition, it will be understood that additional functional components may be included in chat agent 108 and that the functional components depicted may be performed by multiple client systems and may be distributed across multiple client and server systems.

Further, it is important to note that chat agent 108 may support chat communications through a particular chat service provider or through multiple chat service providers. Additionally, it will be understood that while multiple controllers are depicted within chat agent 108 as separate functional components, all or selections of the controllers may be integrated into a single functional component.

For purposes of illustration, chat agent 108 may be described herein, in part, with reference to “user A”, where “user A” is the user logged on via chat agent 108 to chat services. It will be understood that chat agent 108 may facilitate log in for many different users, but for purposes of illustration, the user supported by chat agent 108 is “user A”.

As illustrated, chat agent 108 includes a communication interface controller 302.

Communication interface controller 302 manages chat communication by chat agent 108 via the network sockets opened for supporting bi-directional communication between chat agent 108 and a chat server, such as chat server 102 or between chat agent 108 and another chat agent. It will be understood that communication interface controller 302 may manage chat communications using multiple protocols, including protocols unique to communications between the chat agent and the chat server.

Chat agent 108 also includes a chat sessions controller 304. Chat sessions controller 304 includes a programming interface for enabling “user A” to select to communicate via a chat session with another user who is logged on and receiving chat session requests.

Responsive to “user A” selecting to communicate with another user via a chat session, chat session controller 304 communicates the request to chat server 102 via network interface 302.

Additionally, chat sessions controller 304 handles received requests from other users requesting communication with “user A” via a chat session (e.g. chat requests). Upon receipt of a request from another user to chat with “user A”, chat sessions controller 304 may alert “user A” to the chat request via an output interface accessible to “user A”. In one example, chat sessions controller 304 alerts “user A” to a chat request by adding a pop-up window to a graphical user interface, where the pop-up window indicates the identifier for the user requesting the chat session and the opportunity to accept or decline the request. In another example, chat sessions controller 304 alerts “user A” to a chat request by controlling output of a particular audible output indicating the request. For example, the audible output may include a voice announcement of the identifier of the user requesting the chat session. It will be understood that chat sessions controller 304 may enable “user A” to select a preferred output type to alert “user A” to new chat requests.

In addition, chat agent 108 includes a chat presence controller 306. Chat presence controller 306 may broadcast the presence state for “user A” to chat server 102 for presence update controller 208 to control broadcast of the presence state to other users. In addition, chat presence controller 306 may directly broadcast the presence state for “user A” to another chat agent.

Chat presence controller 306 includes a programming interface for enabling “user A” to select a particular presence state for broadcast to other users. In one embodiment, chat presence controller 306 enables “user A” to select a particular presence state by selecting from among multiple indicators of availability.

In addition, other controllers, such as avoidance controller 312, may automatically adjust a presence state, triggering chat presence controller 306 to broadcast the updated presence state to all or a selection of other users that monitor the presence of “user A”.

Chat presence controller 306 also controls how the presence states for other users are output to “user A”. In one example, “user A” adds user identifiers to a buddy list, where the buddy list indicates those users whose presence state “user A” automatically requests to monitor. User identifiers added to a buddy list are included in buddy list settings 310. Further, within a buddy list, as stored in buddy list settings 310, “user A” may specify groups of users, such as a family group, a business group, a friend group, and other user definable groups. When “user A” receives a chat request from a user that is not included in buddy list settings 310, that user may be considered a “foreign chat user”.

In another embodiment, an avoidance controller 312 automatically selects a new presence state for “user A” that is detected by chat presence controller 306. In particular, first, avoidance controller 312 monitors computer interaction activity by “user A” to detect avoidance activity and calculate avoidance thresholds for “user A”. Avoidance controller 312 stores monitored and analyzed activity for “user A” in avoidance statistics database 314. In particular, avoidance statistics database 314 may include instances of avoidance activity and instances of non-avoidance chat activity.

In one example, avoidance controller 312 monitors computer interaction activity by “user A” and compares the activity with specified types of avoidance activity for “user A” set in avoidance threshold settings 308. For example, “user A” may specify that if a chat request or chat session window, from a user who is not indicated in a buddy list as a business contact, is moved to the background during scheduled work hours, that activity is indicative of avoidance of the chat session. When avoidance controller 312 detects activity that matches one of the specified types of avoidance activity for “user A”, avoidance controller 312 marks the activity as avoidance activity in the record of the activity stored in avoidance statistics database 314.

In another example, avoidance controller 312 monitors computer interaction by “user A” and prompts the user to indicate whether the activity is indicative of that user avoiding a chat session. If “user A” indicates that the user was avoiding the chat session, then avoidance controller 312 marks the activity as avoidance activity in avoidance statistics database 314. In prompting “user A” to indicate whether the activity is indicative of that user avoiding a chat session, avoidance controller 312 may offer options for the user to indicate that the activity is always indicative of avoidance in general, always indicative of avoidance of the requesting user, only indicative of avoidance one time, or not indicative of avoidance. In addition, “user A” may further clarify the conditions upon which the activity would be considered avoidance in other circumstances. Based on responses by “user A” to the prompting, avoidance controller 312 may update the specified types of avoidance activity for “user A” in avoidance threshold settings 308.

For example, when “user A” receives a chat request, accepts the chat request, enters one message in response, and then closes the chat session window, avoidance controller 312 may prompt “user A” to indicate whether the user was avoiding the chat request. If “user A” indicates that the user was avoiding the chat session, then avoidance controller 312 may monitor each time “user A” repeats the same set of actions and add a record of the activity as indicative of avoidance in avoidance statistics database 314.

In another example, when “user A” minimizes multiple chat requests or current chat session windows, but continues interacting with a particular application other than the instant messaging application, avoidance controller 312 may prompt “user A” to indicate whether the user was avoiding the chat request to focus on the particular application. If “user A” indicates that the user was avoiding the chat session, then avoidance controller 312 may monitor each time “user A” repeats the set of actions to detect patterns or percentages of chat request avoided when “user A” also interacts with a particular application before or after avoiding a chat request.

Over time, as avoidance controller 312 gathers records of “user A's” avoidance of chat sessions, avoidance controller 312 may analyze the records to detect patterns, calculate averages and percentages and detect other data that aids in the selection of avoidance thresholds. Although not depicted, avoidance controller 312 may include a specialized analysis controller, such as analysis controller 216, that receives updated control information as general new types of avoidance activity are identified by at a chat server or other chat communication avoidance activity monitoring service.

Avoidance controller 312 may automatically set avoidance thresholds based on the analyzed information and then continue to update avoidance thresholds based on changes to avoidance activity over time. In particular, avoidance thresholds may be set based on the type of avoidance activity, the particular users avoided, the group of users avoided, the type of users avoided, and other conditions. A group of users avoided may be reflected in a grouping within buddy list settings 310. A type of users avoided may include types such as users not currently chatting with “user A”, foreign chat users, and other definable types of users. New avoidance thresholds may be integrated into current avoidance thresholds within avoidance threshold settings 308 automatically or only by user approval from a prompt to select from the new avoidance thresholds. Integrating the new avoidance thresholds into the current avoidance thresholds may require replacing some current avoidance thresholds and adding new avoidance thresholds. Further, new avoidance thresholds may set different avoidance thresholds for different times of day or different activities scheduled in a calendar.

In one example, avoidance controller 312 may select general thresholds. For example, avoidance controller 312 may calculate the percentage of times that “user A” avoided a chat request, out of the total number of chat requests received over a period of time. Further, avoidance controller 312 may calculate the percentage of times that “user A” avoided chat requests from a particular grouping of users in the buddy list, out of the total number of chat requests received from that grouping of users over a period of time. In another example, avoidance controller 312 may calculate the percentage of time each avoidance activity is performed out of the total number avoidance activity records over a period of time.

In another example, avoidance controller 312 may select percentage based thresholds. For example, if over a first time period “user A” received 50 chat requests and avoided 10 chat requests, or 20% of the chat requests, and over a second time period “user A” received 25 chat requests and avoided 5, or 25% of the chat requests, then avoidance controller 312 calculates that normal avoidance activity for a user is about 22% of the requests and sets the general avoidance threshold to 22% over the time period. Thus, if over the time period “user A” receives 20 chat requests and avoids 10 of the requests, or 50% of the chat requests, then avoidance controller 312 will detect that the general avoidance threshold is exceeded and automatically update the presence state to “unavailable” or other state that indicates the lack of availability to receive new chat requests.

In another example, avoidance controller 312 may select number based thresholds. For example, if over a first period of time, “user A” averages three simultaneously open chat sessions at the same time and avoids all new chat request when three windows are already open, then avoidance controller 312 selects a threshold of three open chat sessions and will change the presence state of “user A” to an inactive state when three chat sessions are open.

In one example, avoidance controller 312 may select pattern based thresholds. For example, avoidance controller 312 may detect that when “user A” is currently chatting with “user B”, then “user A” is going to avoid all chat requests except those from a manager. Avoidance controller 312 would set a threshold of 1% of the chat requests when “user B” is a current chat session participant and set the presence state update to “unavailable” except for users of manager status. In another example, avoidance controller 312 may detect that when “user A” is using a particular application, “user A” avoids all chat requests from foreign chat users. Avoidance controller 312 would set a threshold of 10% of the chat requests from foreign chat users when “user A” is using the particular application. In yet another example, avoidance controller 312 may detect that if “user A” avoids more than three chat requests in sequence, “user A” will continue to avoid chat requests, and set a threshold of three chat requests in sequence and set the presence state to update to “unavailable” or other state that indicates the lack of availability to receive new chat requests.

Additionally, avoidance controller 312 may calculate percentages and detect patterns of avoidance and then present these determinations to “user A” for selection by “user A”. User selected thresholds are added to avoidance threshold settings 308 and applied by avoidance controller 312.

As directed by avoidance controller 312, chat presence controller 306 may output an avoidance-based presence state for “user A” to chat server 102. An avoidance-based presence state may include a single or multiple presence state indicators. In addition, a presence state update may specify the user, users, groups of users, or types of users, to which the presence state update should be broadcast. For example, an avoidance-based presence state may specify to broadcast the presence state update only to those users not currently participating in a chat session with “user A”.

In another embodiment, chat presence controller 306 may pass computer interaction activity indicators to a chat server, such that the avoidance controller of a chat server, such as avoidance controller 210 of chat server 102, may monitor for avoidance activity, select avoidance thresholds, and responsive to current activity exceeding the thresholds, adjust a user's presence state, in the same manner as described with reference to avoidance controller 312. Additionally, avoidance threshold settings database 214 of chat server 102 may store avoidance thresholds and avoidance statistics for a user, such that when the user logs in at chat agent 108, chat server 102 downloads the avoidance thresholds and avoidance statistics to chat agent 108, wherein chat agent 108 then performs the avoidance based presence state monitoring and updates. In addition, when the user logs out of chat agent 108, chat agent 108 updates chat server 102 with any changes to the avoidance thresholds and the avoidance statistics.

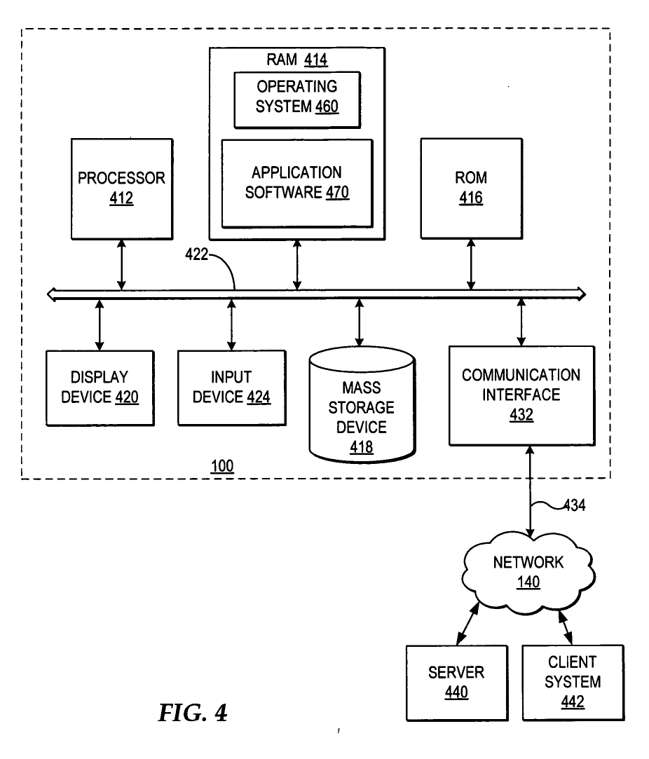

With reference now to FIG. 4, a block diagram depicts one embodiment of a computing system through which the chat server or chat client system and present method and program product may be implemented. The present invention may be executed in a variety of systems, including a variety of computing systems and electronic devices.

Computer system 400 includes a bus 422 or other communication device for communicating information within computer system 400, and at least one processing device such as processor 412, coupled to bus 422 for processing information. Bus 422 preferably includes low-latency and higher latency paths that are connected by bridges and adapters and controlled within computer system 400 by multiple bus controllers. When implemented as a chat server, computer system 400 may include multiple processors designed to improve network servicing power.

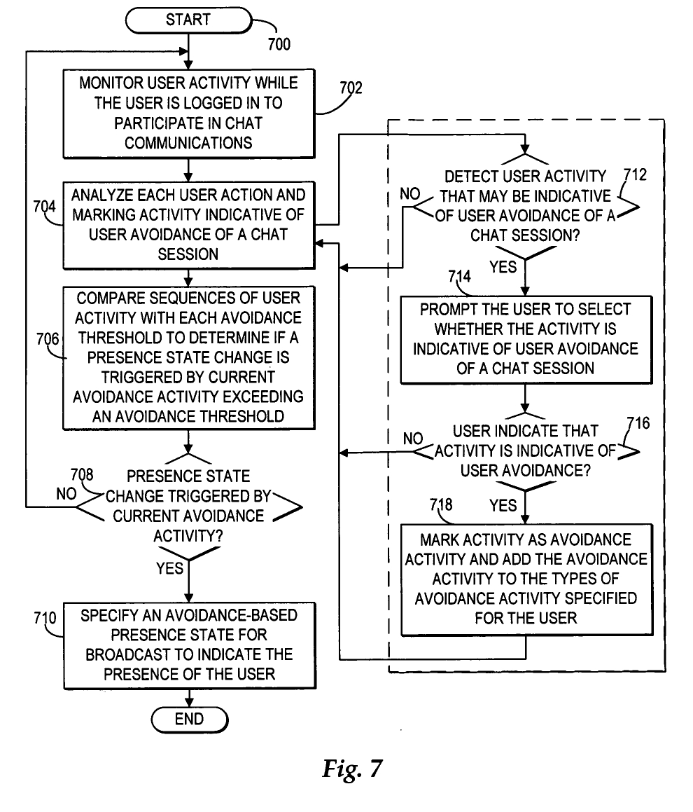

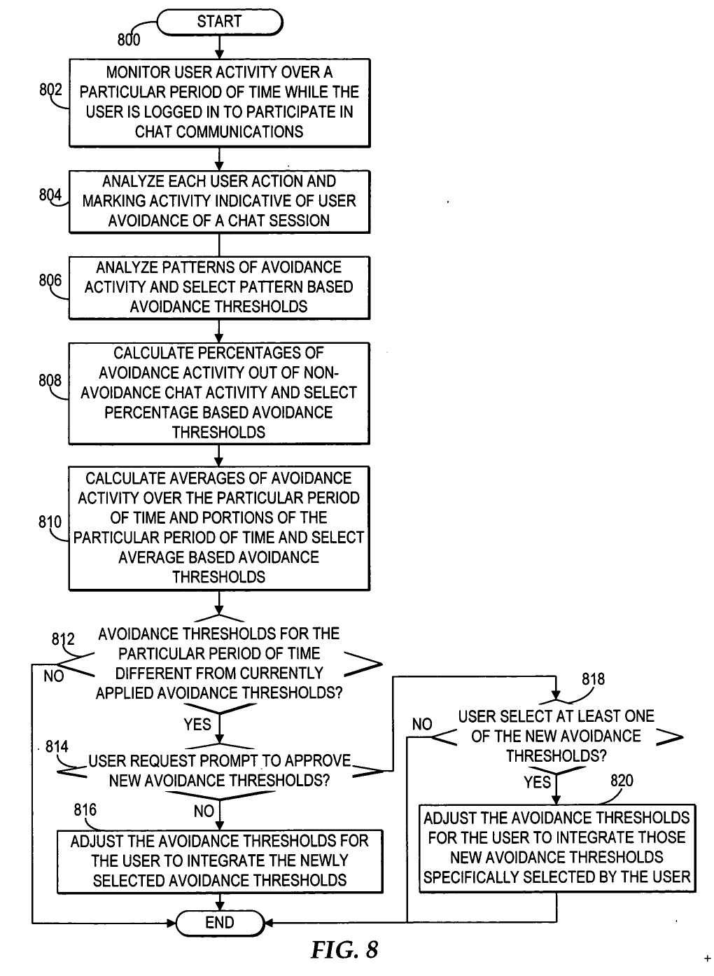

Processor 412 may be a general-purpose processor such as IBM's PowerPC™ processor that, during normal operation, processes data under the control of an operating system 460, application software 470, middleware (not depicted), and other code accessible from a dynamic storage device such as random access memory (RAM) 414 and a static storage device such as Read Only Memory (ROM) 416. Operating system 460 may provide a graphical user interface (GUI) to the user. In one embodiment, application software 470 contains machine executable instructions for controlling chat communications that when executed on processor 412 carry out the operations depicted in the flowcharts of FIGS. 7 and 8 and other operations described herein with reference to the controllers in chat server 102 or chat agent 108. Alternatively, the steps of the present invention might be performed by specific hardware components that contain hardwired logic for performing the steps, or by any combination of programmed computer components and custom hardware components.

The chat communications of the present invention may be provided as a computer program product, included on a machine-readable medium having stored thereon the machine executable instructions used to program computer system 400 to perform a process according to the present invention. The term “machine-readable medium” as used herein includes any medium that participates in providing instructions to processor 412 or other components of computer system 400 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 400 can read and which is suitable for storing instructions. In the present embodiment, an example of a non-volatile medium is mass storage device 418 which as depicted is an internal component of computer system 400, but will be understood to also be provided by an external device. Volatile media include dynamic memory such as RAM 414. Transmission media include coaxial cables, copper wire or fiber optics, including the wires that comprise bus 422. Transmission media can also take the form of acoustic or light waves, such as those generated during radio frequency or infrared data communications.

Moreover, the present invention may be downloaded as a computer program product, wherein the program instructions may be transferred from a remote computer such as a server 440 or client system 442 to requesting computer system 400 by way of data signals embodied in a carrier wave or other propagation medium via a network link 434 (e.g. a modem or network connection) to a communications interface 432 coupled to bus 422. Communications interface 432 provides a two-way data communications coupling to network link 434 that may be connected, for example, to a local area network (LAN), wide area network (WAN), or directly to an Internet Service Provider (ISP). In particular, network link 434 may provide wired and/or wireless network communications to one or more networks.

Network link 434 in turn provides data communication services through network 140. Network link 434 and network 402 both use electrical, electromagnetic, or optical signals that carry digital data streams. The signals through the various networks and the signals on network link 434 and through communication interface 432, which carry the digital data to and from computer system 400, are exemplary forms of carrier waves transporting the information.

When implemented as a chat server, computer system 400 typically includes multiple communication interfaces accessible via multiple peripheral component interconnect (PCI) bus bridges connected to an input/output controller. In this manner, computer system 400 allows connections to multiple network computers.

In addition, computer system 400 typically includes multiple peripheral components that facilitate communication. These peripheral components are connected to multiple controllers, adapters, and expansion slots coupled to one of the multiple levels of bus 422. For example, input device 424 may include, for example, a microphone, a keyboard, a mouse, or other input peripheral device, communicatively enabled on bus 422 controlling inputs. In addition, for example, a display device 420 communicatively enabled on bus 422 for controlling outputs may include, for example, one or more graphical display devices, but may also include other output interfaces, such as an audio output interface. In alternate embodiments of the present invention, additional input and output peripheral components may be added.

Those of ordinary skill in the art will appreciate that the hardware depicted in FIG. 4 may vary. Furthermore, those of ordinary skill in the art will appreciate that the depicted example is not meant to imply architectural limitations with respect to the present invention.

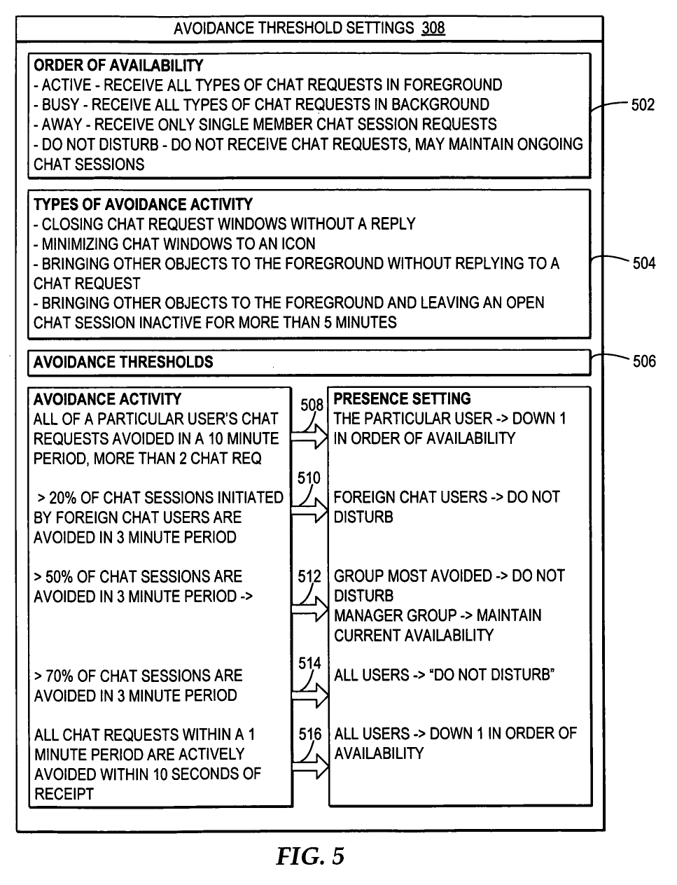

With reference now to FIG. 5, a block diagram illustrates avoidance threshold settings for a particular user, such as “user A” described in FIG. 4. As illustrated, avoidance threshold settings 308 includes multiple types of information including order of availability 502, types of avoidance activity 504 and avoidance threshold 506. It will be understood that avoidance threshold settings 308 may include other or additional types of information that aids avoidance controller 312 is managing a presence state based on current avoidance of chat sessions. In addition, it will be understood that avoidance threshold settings 308 may be located within a chat server and other systems.

In the example, order of availability settings 502 include multiple presence state indicators and rules for each presence state indicator. In the example, for a presence state indicator of “active” the user may receive all types of chat requests in the foreground; for a presence state indicator of “busy” the user may receive all types of chat requests in the background; for a presence state indicator of “away” the user may receive only single member chat session requests; and for a presence state indicator of “do not disturb”, the will not receive chat requests, but may maintain ongoing chat sessions. Although not depicted, a different graphical indicator, such as a color, may be associated with each presence state indicator.

In addition, in the example, types of avoidance activity 504 include multiple types of activity indicative of avoidance of chat sessions by a particular user. In the example, types of avoidance activity may be specified by a user or by an avoidance controller. In the example, types of avoidance activity specified by an avoidance controller may include “closing chat request windows without a reply” and “minimizing chat windows to an icon.” In addition, in the example, types of avoidance activity specified by a user may include “bringing other objects to the foreground without replying to a chat request” and “bringing other objects to the foreground and leaving an open chat sessions inactive for more than 5 minutes.” By other objects, a user may specify non-chat session related objects. It will be understood that additional or other types of activity indicative of avoidance of a chat session may be included in types of avoidance activity 504. In particular, as an avoidance controller monitors a user's interaction with a computer system, the avoidance controller may detect patterns indicative of avoidance activity and either automatically add the patterns to types of avoidance activity 504 or prompt a user to select to add the patterns to types of avoidance activity 504.

Further, in the example, avoidance thresholds 506 include multiple types of thresholds and the presence setting associated with each threshold. In the example, as illustrated at reference numeral 508, if all of a particular user's chat requests are avoided within a 10 minute period, and there are more than 2 chat requests, then the presence state broadcast to the particular user is reduced by one position within the order of availability. As depicted at reference numeral 510, if more than 20% of the chat sessions initiated by foreign chat users are avoided within a three minute period, then the presence state broadcast to foreign chat users changes to “do not disturb”. As illustrated at reference numeral 512, if more than 50% of the total chat sessions are avoided in a 3 minute period, then the presence state broadcast to the group of users most avoided is set to “do not disturb”, but the presence state to any user in the “manager group” is maintained at the current availability setting. As depicted at reference numeral 514, if more than 70% of the total chat sessions are avoided in a 3 minute period, then the presence state broadcast to all users is “do not disturb”. As illustrated at reference numeral 516, if all chat requests received within a 1 minute period are actively avoided within 10 seconds of receipt, then the presence state to all users is decreased by one position within the order of availability.

In particular, it is important to note that when setting an avoidance-based presence setting for a particular user, group of users, type of users, or all users, a user may select whether the presence state will update for those users with whom active chat sessions are open.

Further, a user may specify other general preferences, such as never setting the presence state broadcast to a user designated as a manager to “do not disturb”.

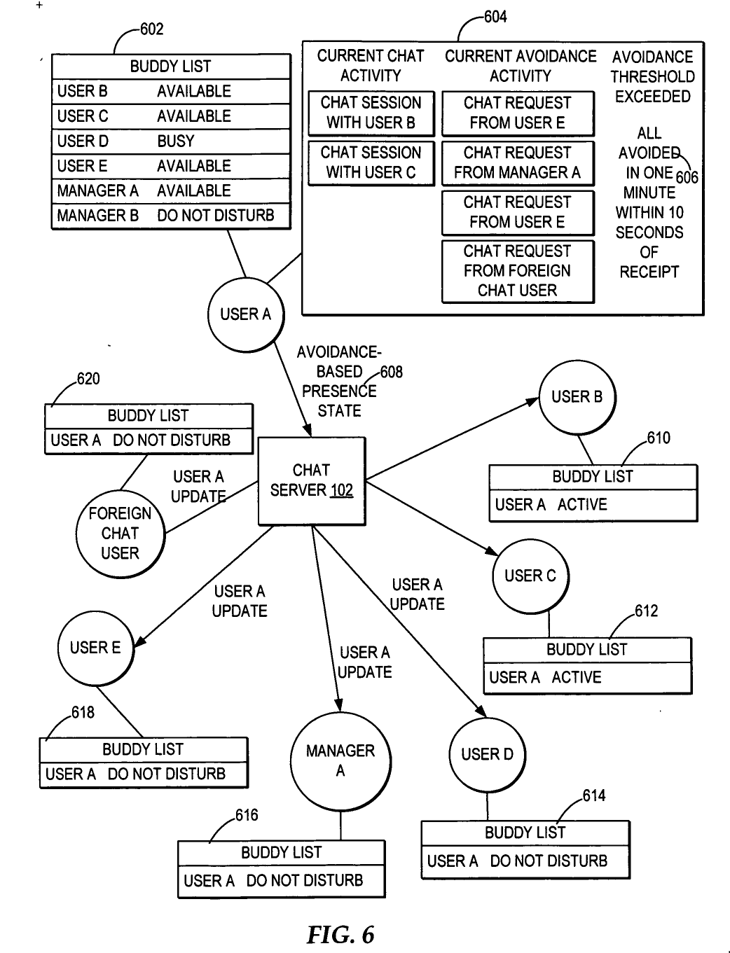

Referring now to FIG. 6, an illustrative diagram depicts one example of an avoidance-based presence state update. In the example, a presence state for “user A” is updated with an avoidance-based presence state to those users not currently participating in a chat session with “user A”.

As illustrated, “user A” has a buddy list 602 with “user B”, “user C”, “user D”, “user E”, “manager A”, and “manager B”. Buddy list 602 includes a presence state for each user, as received from chat server 102 or directly from another client system. Although not depicted, the buddies may be further classified according to group or type.

In addition, as illustrated, a chat avoidance determination 604 for “user A” includes current chat activity, current avoidance activity, and the avoidance threshold exceeded. In the example, “user A” has separate chat sessions open with “user B” and “user C”. In addition, in the example, avoidance activity is detected from avoidance of chat requests from “user E”, “manager A”, “user E” and a “foreign chat user” not included in buddy list 602. Although not depicted, a time of arrival and a time of avoidance may be tracked for each chat request.

An avoidance controller monitoring the current chat activity and current avoidance activity detects that an avoidance threshold is exceeded. In particular, as illustrated at reference numeral 606, the avoidance controller detects that the chat requests are all avoided in one minute, without 10 seconds of receipt of each request. Referring to avoidance threshold 516 in FIG. 5, exceeding this threshold triggers a presence setting of “do not disturb” to all users. In particular, “user A” has selected that “all users” does not include those users with whom “user A” is currently chatting; in the example, “all users” does not include “user B” or “user C”.

In the example, each user identifier represents the client system at which the user is logged in through a chat agent facilitates communication with chat server 102. The avoidance controller for “user A”, responsive to detecting the triggered avoidance-based presence state, sends the updated presence state to chat server 102, as illustrated at reference numeral 608. Chat server 102 then broadcasts the presence state update for “user A” to those users with whom “user A” does not have an open chat session. In the example, buddy list 610 for “user B” and buddy list 612 for “user C”, do not receive updates to the presence state of “user A” and continue to view “user A” as “active”. Buddy list 614 for “user D”, buddy list 616 for “manager A”, buddy list 618 for “user E”, and buddy list 620 for “foreign chat user” are updated with the avoidance-based presence state of “user A” which is updated to “do not disturb”. In particular, “foreign chat user” may monitor the presence state of “user A” in buddy list 620 even though “user A” does not include “foreign chat user” is buddy list 602.

With reference now to FIG. 7, a high level logic flowchart depicts a process and program for specifying avoidance based presence states for chat users. As illustrated, the process starts at block 700 and thereafter proceeds to block 702. Block 702 depicts the avoidance controller monitoring user activity while a user is logged in to participate in chat communications. Next, block 704 illustrates the avoidance controller analyzing each user action and marking activity indicative of user avoidance of a chat session. Thereafter, block 706 depicts the avoidance controller comparing the sequences of user activity with each avoidance threshold to determine if a presence state change is triggered by current avoidance activity exceeding an avoidance threshold, and the process passes to block 708.

Block 708 illustrates a determination by the avoidance controller whether a presence state change is triggered by current avoidance activity. If a presence state is not triggered by current avoidance activity, then the process returns to block 702. If a presence state is triggered by current avoidance activity, then the process passes to block 710. Block 710 illustrates the avoidance controller specifying a presence state for broadcast to indicate the avoidance based presence of the user, and the process ends. As previously described, the presence state may be specified with an indicator only for update to a selected user, group of users, or type of users. In addition, as previously describe, the presence state may include multiple indictors with each indicator specified according to recipient. In addition, it is important to note that the presence state change is then automatically set at the chat agent or chat server and then the chat agent or chat server modules, such as chat presence controller 306 or presence update controller 208, control updating users with the avoidance-based presence state.

Returning to block 704, in analyzing each user action and marking activity indicative of user avoidance of a chat session, the avoidance controller may compare the activity with a list of types of avoidance activity, such as types of avoidance activity 404 in avoidance threshold settings 308. In addition, as illustrated at block 712, the avoidance controller may detect whether activity may be indicative of user avoidance of a chat session for that particular action or in a pattern of actions. In one example, user activity may be indicative of user avoidance if the activity is similar to a specified type of avoidance activity. In another example, user activity may be indicative of user avoidance if the avoidance controller detects a pattern of non-responsiveness to chat sessions by a user. If user activity may be indicative of user avoidance of a chat session, then the process passes to block 714. Block 714 depicts the avoidance controller prompting the user to select whether the activity is indicative of user avoidance of a chat session. Next, block 716 depicts a determination by the avoidance controller whether the user selects that the activity is indicative of user avoidance of the chat session. If the user selects that the activity is indicative of user avoidance of a chat session, then the process passes to block 718. Block 718 depicts the avoidance controller marking the activity as avoidance activity and adding the avoidance activity to the types of avoidance activity specified for the user, and the process returns to block 704. It is important to note that a user may select that the activity is indicative of user avoidance by user, such as a particular other user, a particular group of users, a particular type of users, user avoidance by time or day, or user avoidance with other criteria specified by the user.

Referring now to FIG. 8, a high level logic flowchart depicts a process and program for monitoring avoidance activity for a particular user and setting avoidance thresholds based on the monitored avoidance activity. As illustrated, the process starts at block 800 and thereafter proceeds to block 802. Block 802 illustrates the avoidance controller monitoring user activity over a particular period of time while a user is logged in to participate in chat communications. Next, block 804 depicts the avoidance controller analyzing each user action to determine if the activity is indicative of user avoidance of a chat session, and the process passes to block 806. In particular, in detecting activity indicative of user avoidance of a chat session, the avoidance controller may compare each activity with a list of types of avoidance activity. In addition, in detecting activity indicative of user avoidance of a chat session, the avoidance controller may trigger the process illustrated in FIG. 7 starting at block 712.

Block 806 illustrates the avoidance controller analyzing the patterns of avoidance activity and selecting pattern based avoidance thresholds. Next, block 808 depicts the avoidance controller calculating percentages of avoidance activity compare with non-avoidance chat activity and selecting percentage based avoidance thresholds. Thereafter, block 810 illustrates calculating averages of avoidance activity over the particular period of time and portions of the time period and selecting average based avoidance thresholds, and the process passes to block 812.

Block 812 depicts the avoidance controller determining whether the new avoidance thresholds for the particular period of time are different from currently applied avoidance thresholds. If the new avoidance thresholds are not different, then the process ends. If the new avoidance thresholds are different, then the process passes to block 814. Block 814 illustrates a determination whether the user requests a prompt to approve new avoidance thresholds. If the user does not request a prompt, then the process passes to block 816. Block 816 depicts adjusting the avoidance thresholds for the user to integrate the newly selected avoidance thresholds into the current avoidance thresholds, and the process ends. Returning to block 814, if the user does request a prompt, then the process passes to block 818. Block 818 illustrates a determination whether the user selects at least one of the new avoidance thresholds. In particular, in selecting a new avoidance threshold, a user may adjust a value selected in the threshold. If a user does not select at least one new avoidance threshold, then the process ends. If a user selects at least one new avoidance threshold, then the process passes to block 820. Block 820 depicts adjusting the current avoidance thresholds for the user to integrate those new avoidance thresholds specifically selected by the user, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for controlling adjustment of a chat presence state for a particular user for indicating availability of said particular user to participate in new chat sessions with at least one other user from among a plurality of users, in at least one computer system in communication with a network, wherein said at least one computer system comprises at least one from among a chat server that facilitates chat sessions between a plurality of client systems logged onto by said plurality of users and a particular client system from among said plurality of client systems communicatively connected to said chat server logged onto by said particular user from among said plurality of users, comprising:
detecting, at said computer system, a selection of chat sessions avoided by said particular user over a particular period of time from among a plurality of total chat sessions directed to said particular user, wherein said particular user avoids each of said selection of chat sessions through at least one of a plurality of separate types of avoidance activity, wherein said user verifies each said plurality of separate types of avoidance activity are representative of actual actions taken by said particular user to avoid chat sessions; and
automatically setting at least one avoidance threshold based on at least one threshold characteristic of said selection of chat sessions avoided by said particular user, wherein future avoidance activity by said particular use that exceeds said avoidance threshold triggers said computer system to automatically adjust said chat presence state of said particular user to indicate lack of availability to participate in a new chat session.

2. The method according to claim 1, further comprising:
detecting a second selection of chat sessions avoided by said particular user through at least one of said plurality of separate types of avoidance activity over a different period of time;
comparing said second selection of chat sessions avoided by said particular user with said avoidance threshold set for said particular user; and
responsive to second selection of chat sessions exceeding said avoidance threshold, automatically adjusting said chat presence state for said particular user to indicate lack of availability of said particular user to participate in a new chat session.

3. The method according to claim 2, wherein automatically adjusting said chat presence state for said particular user to indicate lack of availability to participate in a new chat session, further comprises:
automatically adjusting said chat presence state for said particular user for broadcast to at least one from among a first selection of said plurality of users not currently in an open chat session with said particular user and a second selection of said plurality not blocked from receiving avoidance-based presence state updates.

4. The method according to claim 1, further comprising:
setting said avoidance threshold to trigger said computer system to adjust said chat presence state of said particular user to indicate lack of availability to participate in a new chat session and to block a selection of said plurality of users receiving said chat presence state from initiating said new chat session with said particular user.

5. The method according to claim 1, further comprising:
setting said avoidance threshold to trigger said computer system to adjust said chat presence state of said particular user to indicate lack of availability to participate in a new chat session and to adjust the placement of any new chat sessions from prior display within a foreground of a display area to display with a background of said display area.

6. The method according to claim 1, wherein automatically setting at least one avoidance threshold based on at least one threshold characteristic of said selection of chat sessions avoided by said particular user, further comprises:
detecting said threshold characteristic by calculating a percentage of said selection of chat sessions avoided by said particular user over said particular period of time out of said plurality of total chat session directed to said particular user.

7. The method according to claim 1, wherein automatically setting at least one avoidance threshold based on at least one threshold characteristic of said selection of chat sessions avoided by said particular user, further comprises:
detecting said threshold characteristic from a pattern of avoidance in said selection of chat sessions avoided by said particular user over said particular period of time.

8. The method according to claim 1, wherein automatically setting at least one avoidance threshold based on at least one threshold characteristic of said selection of chat sessions avoided by said particular user, further comprises:
automatically setting at least one avoidance threshold based on avoidance of at least one of at least one other user, at least one buddy list grouping of users, and at least one type of user.

9. The method according to claim 1, further comprising:
detecting a second selection of chat sessions avoided by said particular user through at least one of said plurality of separate types of avoidance activity over a different period of time;
detecting at least one second threshold characteristic of said second selection of chat sessions avoided by said particular user; and
adjusting said at least one avoidance threshold to incorporate said second threshold characteristic.

10. A system for controlling adjustment of a chat presence state for a particular user for indicating availability of said particular user to participate in new chat sessions with at least one other user from among a plurality of users, comprising:
at least one computer system in communication with a network, wherein said at least one computer system comprises at least one from among a chat server that facilitates chat sessions between a plurality of client systems logged onto by said plurality of users and a particular client system from among said plurality of client systems communicatively connected to said chat server logged onto by said particular user from among said plurality of users, said at least one computer system further comprising:
means for detecting a selection of chat sessions avoided by said particular user over a particular period of time from among a plurality of total chat sessions directed to said particular user, wherein said particular user avoids each of said selection of chat sessions through at least one of a plurality of separate types of avoidance activity, wherein said user verifies each said plurality of separate types of avoidance activity are representative of actual actions taken by said particular user to avoid chat sessions; and
means for automatically setting at least one avoidance threshold based on at least one threshold characteristic of said selection of chat sessions avoided by said particular user, wherein future avoidance activity by said particular use that exceeds said avoidance threshold triggers said computer system to automatically adjust said chat presence state of said particular user to indicate lack of availability to participate in a new chat session.

11. The system according to claim 10, said at least one computer system further comprising:
means for detecting a second selection of chat sessions avoided by said particular user through at least one of said plurality of separate types of avoidance activity over a different period of time;
means for comparing said second selection of chat sessions avoided by said particular user with said avoidance threshold set for said particular user; and
means, responsive to second selection of chat sessions exceeding said avoidance threshold, for automatically adjusting said chat presence state for said particular user to indicate lack of availability of said particular user to participate in a new chat session.

12. The system according to claim 10, wherein said means for automatically adjusting said chat presence state for said particular user to indicate lack of availability to participate in a new chat session, further comprises:
means for automatically adjusting said chat presence state for said particular user for broadcast to at least one from among a first selection of said plurality of users not currently in an open chat session with said particular user and a second selection of said plurality not blocked from receiving avoidance-based presence state updates.

13. The system according to claim 10, said at least one computer system further comprising:
means for setting said avoidance threshold to trigger said computer system to adjust said chat presence state of said particular user to indicate lack of availability to participate in a new chat session and to block a selection of said plurality of users receiving said chat presence state from initiating said new chat session with said particular user.

14. The system according to claim 10, said at least one computer system further comprising:
means for setting said avoidance threshold to trigger said computer system to adjust said chat presence state of said particular user to indicate lack of availability to participate in a new chat session and to adjust the placement of any new chat sessions from prior display within a foreground of a display area to display with a background of said display area.

15. The system according to claim 10, wherein said means for automatically setting at least one avoidance threshold based on at least one threshold characteristic of said selection of chat sessions avoided by said particular user, further comprises:
means for detecting said threshold characteristic by calculating a percentage of said selection of chat sessions avoided by said particular user over said particular period of time out of said plurality of total chat session directed to said particular user.

16. The system according to claim 10, wherein said means for automatically setting at least one avoidance threshold based on at least one threshold characteristic of said selection of chat sessions avoided by said particular user, further comprises:
means for detecting said threshold characteristic from a pattern of avoidance in said selection of chat sessions avoided by said particular user over said particular period of time.

17. The system according to claim 10, wherein said means for automatically setting at least one avoidance threshold based on at least one threshold characteristic of said selection of chat sessions avoided by said particular user, further comprises:
means for automatically setting at least one avoidance threshold based on avoidance of at least one of at least one other user, at least one buddy list grouping of users, and at least one type of user.

18. The system according to claim 10, said at least one computer system further comprising:
means for detecting a second selection of chat sessions avoided by said particular user through at least one of said plurality of separate types of avoidance activity over a different period of time;
means for detecting at least one second threshold characteristic of said second selection of chat sessions avoided by said particular user; and
means for adjusting said at least one avoidance threshold to incorporate said second threshold characteristic.

19. A program for controlling adjustment of a chat presence state for a particular user for indicating availability of said particular user to participate in new chat sessions with at least one other user from among a plurality of user, said program embodied in a computer-readable medium, said program comprising computer-executable instructions which cause a computer to perform the steps of:
detecting a selection of chat sessions avoided by said particular user over a particular period of time from among a plurality of total chat sessions directed to said particular user, wherein said particular user avoids each of said selection of chat sessions through at least one of a plurality of separate types of avoidance activity, wherein said user verifies each said plurality of separate types of avoidance activity are representative of actual actions taken by said particular user to avoid chat sessions; and
automatically setting at least one avoidance threshold based on at least one threshold characteristic of said selection of chat sessions avoided by said particular user, wherein future avoidance activity by said particular use that exceeds said avoidance threshold triggers automatic adjustment of said chat presence state of said particular user to indicate lack of availability to participate in a new chat session.

20. The program according to claim 19, said program further comprising computer-executable instructions with cause said computer to perform the steps of:
detecting a second selection of chat sessions avoided by said particular user through at least one of said plurality of separate types of avoidance activity over a different period of time;
comparing said second selection of chat sessions avoided by said particular user with said avoidance threshold set for said particular user; and
responsive to second selection of chat sessions exceeding said avoidance threshold, automatically adjusting said chat presence state for said particular user to indicate lack of availability of said particular user to participate in a new chat session.
